(19) United States
(12) Patent Application Publication
(10) Pub. No.: US 2001/0027691 A1
(43) Pub. Date: Oct. 11, 2001

(54) Automatic trasmission

(75) Inventors: Mitsuo Kayano, Hitachi (JP); Toshimichi Minowa, Mito (JP); Takashi Okada, Hitachi (JP); Tatsuya Ochi, Hitachi (JP); Hiroshi Sakamoto, Hitachi (JP)

Correspondence Address: Evenson, Mckeown,, Edwards & Lenehan, P.L.L.C., 1200 G St., N.W., Suite 700, Washington, DC, 20005, US

(73) Assignee: Hitachi Ltd.

(21) Appl. No.: 09/799,041

(22) Filed: Mar. 6, 2001

(30) Foreign Application Priority Data
Apr. 25, 2000 (JP) 2000-124079
Apr. 4, 2000 (JP) 2000-102267

(51) Int. Cl. F16H 3/12

(52) U.S. Cl. 74/339

(57) ABSTRACT

The object of the present invention is to modify the shock originated from engaging and disengaging of a clutch during acceleration, when using a mesh type transmission provided with a clutch for engaging and disengaging the shift gear and the output shaft. A mesh type automatic transmission equipped with an input shaft 300 for introducing power of an engine, a plurality of shift gears 301, 303, 304, 306, 310, a plurality of cogged clutches 302, 305, 308, an output shaft 323 for outputting driving force, a counter shaft 315, and a plurality of counter gears 314, 316, 317, 318, 322, for transmitting power of the engine to the output shaft 323 by rotating the input shaft 300 with the power of the engine, rotating the counter shaft 315 by rotation of the input shaft 300, and transmitting rotation of the counter shaft 315 to the output shaft 323 via the counter gears 314, 316, 317, 318, 322 with the automatic shifting by engaging and disengaging the cogged clutches 302, 305, 308 to one of the shift gears 301, 303, 304, 306, 310 corresponding to the speed, wherein an assist mechanism 6 for transmitting rotational force of the input shaft 300 to the output shaft 323 by transmitting rotation of the counter shaft 315 via the assist gear 325, during the period of disengagement of a gear 301, 303, 304, 306, 310 to engagement of a new gear 301, 303, 304, 306, 310 at shifting, is provided to the output shaft 323.

### FIELD OF THE INVENTION

The present invention relates to an automatic transmission.

### DESCRIPTION OF THE RELATED ART

Heretofore, there is known an automatic transmission using a mechanism of a conventional manual transmission, that is, mesh gear type transmission as the transmission device, which also is provided with a clutch for engaging and disengaging the engine with the transmission, and an actuator for moving the clutch for engaging and disengaging each gear with the output shaft, and which performs automatic shifting by controlling hydraulic pressure to the actuator, for performing engagement and disengagement of the clutch.

### SUMMARY OF THE INVENTION

In a conventional automatic transmission thus constituted, there exists a condition where the cogged clutch is engaged to none of the gears, that is, a neutral condition.

In such neutral condition, that is, the condition where the cogged clutch is engaged to none of the gears during shifting from 1st gear to 2nd gear, from 2nd gear to 3rd gear, from 3rd gear to 4th gear, and from 4th gear to 5th gear, the driver feels a state of shock as if the vehicle has decelerated, even when the vehicle is accelerating, because the cogged clutch during shifting is meshed with none of the gears so that the acceleration power is not transmitted to the output shaft. This results in poor drivability.

The object of the present invention is to provide an automatic transmission that moderates the shock originated at engagement and disengagement of the clutch during acceleration.

In order to achieve the above-mentioned object, the present invention provided a mesh type automatic transmission for transmitting power of the engine to an output shaft by rotating an input shaft with the power of the engine, rotating a counter shaft by rotation of the input shaft, and transmitting rotation of the counter shaft to the output shaft via a counter gear with automatic shifting by engaging and disengaging the cogged clutch to one of the shift gears corresponding to speed; wherein an assist mechanism for transmitting rotational force of the input shaft to the output shaft, in the period where none of the cogged clutches other than the starting clutch is engaged to the shift gear during switching of the cogged clutch, is provided to the output shaft.

According to another aspect of the present invention, the assist mechanism is provided to the rearward side of a car body than the rearmost gear of the output shaft.

According to still another aspect of the present invention, the assist mechanism starts engaging when a switch command of the cogged clutch is output before the cogged clutch currently engaged with the shift gear is completely disengaged, engages corresponding to the torque of the engine to transmit rotational force of the input shaft to the output shaft when the cogged clutch is completely disengaged from the engaged shift gear, and disengages when the cogged clutch is engaged with the shift gear to be engaged according to the switch command.

According to still another aspect of the present invention, the assist mechanism is comprised of an assist clutch, which is constituted from a clutch plate fixed to the output shaft and rotated with the output shaft, and from an assist gear provided so as to rotate freely on the output shaft for transmitting rotation of the counter shaft to the clutch plate by pressing against the clutch plate, and a counter assist gear for the highest gear fixed to the counter shaft and meshed with the assist gear of the assist clutch, and the rotation of the counter assist gear is transmitted to the output shaft via the assist gear and the clutch plate, based on an assist command.

### BRIEF DESCRIPTION OF THE DRAWINGS

FIG. 1 is an overall structural view of the automatic transmission comprising an embodiment of the present invention;

FIG. 2 is an enlarged view of the assist mechanism shown in FIG. 1;

FIG. 3 is a right side view of the automatic transmission shown in FIG. 1;

FIG. 4 is a view indicating the position where the automatic transmission according to the present invention is provided in a car body of an automobile;

FIG. 5 is a view explaining the engaging and disengaging operation of the assist mechanism during shifting;

FIG. 6 is a view explaining the engaging and disengaging operation of the assist mechanism during shifting; and

FIG. 7 is a view explaining the engaging and disengaging operation of the assist mechanism during shifting.

### DETAILED DESCRIPTION OF PREFERRED EMBODIMENTS

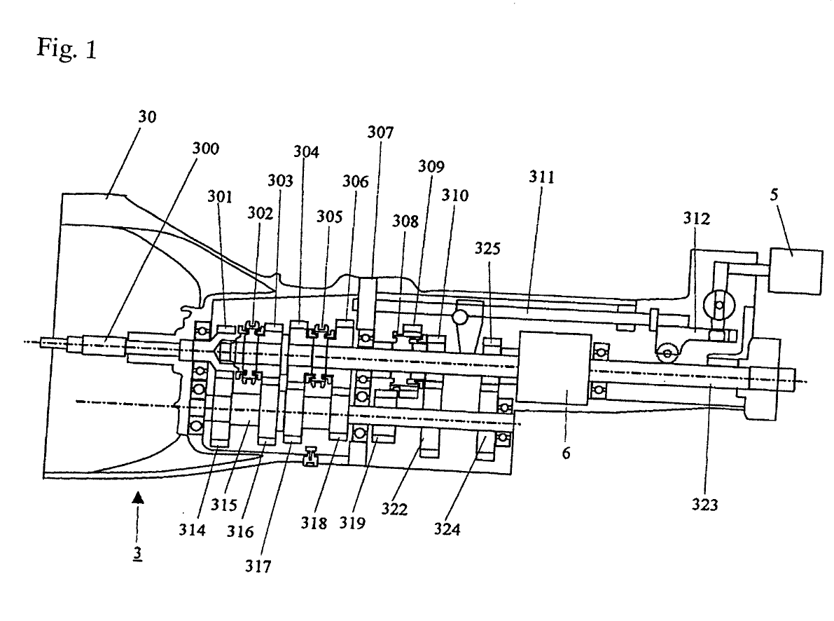

The embodiment of the automatic transmission according to the present invention will be explained below referring to FIG. 1 through FIG. 7.

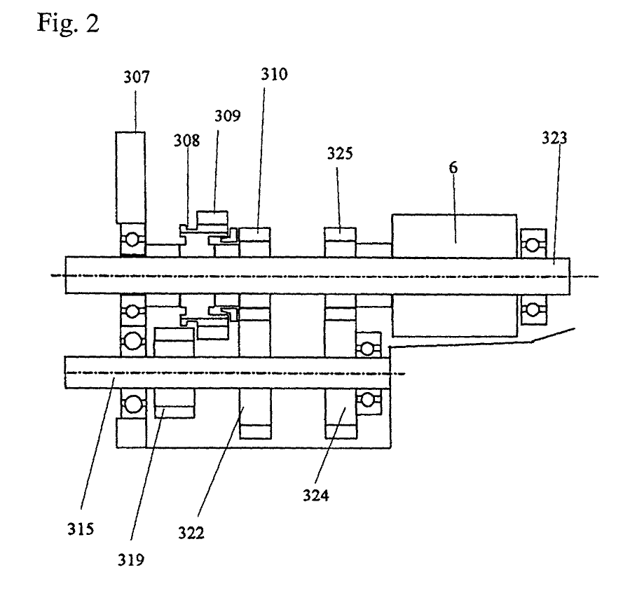

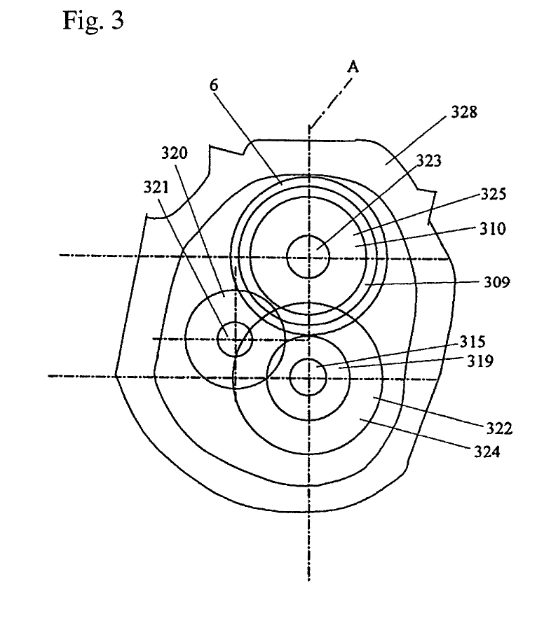

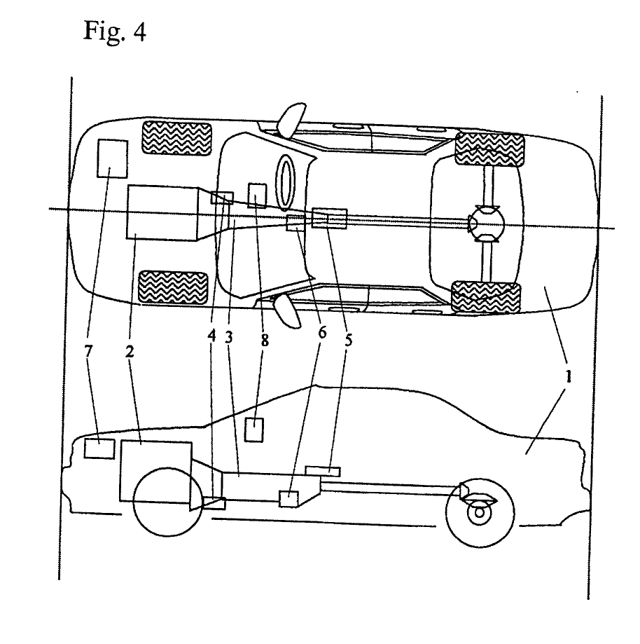

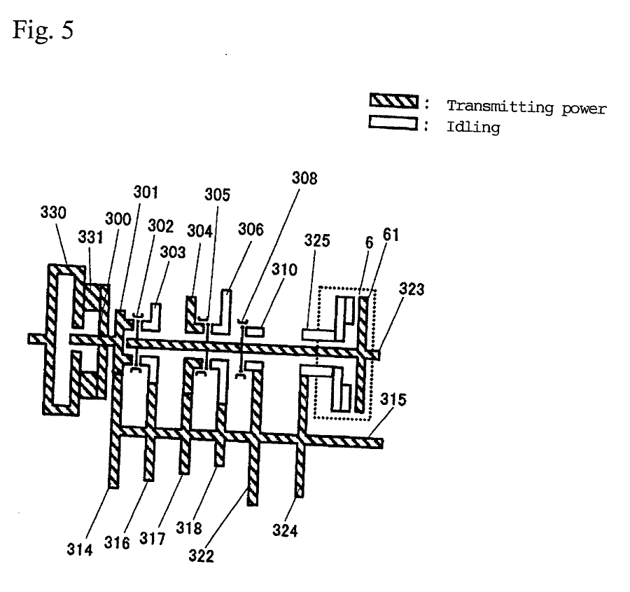

FIG. 1 is an overall structural view of the automatic transmission comprising an embodiment of the present invention, FIG. 2 is an enlarged view of the assist mechanism shown in FIG. 1, FIG. 3 is a right side view of the automatic transmission shown in FIG. 1, FIG. 4 is a view indicating the position where the automatic transmission according to the present invention is provided in a car body of an automobile, and FIG. 5 through FIG. 7 are views explaining the engaging and disengaging operation of the assist mechanism during shifting.

In FIG. 1, an automatic transmission 3 is stored inside a transmission case 30. In the transmission case 30, an input shaft 300 rotated by engaging with a starting clutch, which is not illustrated, is supported so as to rotate freely. A drive gear 301 is fixed to the end of the input shaft 300 at the rearward direction of the vehicle. As the input shaft 300 rotates, the drive gear 301 rotates along with the rotation of the input shaft 300. Also, opposed to the drive gear 301, an output shaft 323 is provided so as to rotate freely on the extension of the input shaft 300 without contacting the drive gear 301, so that the axial center of the output shaft 323 coincides with the axial center of the input shaft 300.

Also, below the output shaft 323, a counter shaft 315 is supported so as to rotate freely, in parallel to the output shaft 323. A counter drive gear 314 is fixed to the side end of the counter shaft 315 at the frontward direction of the car body. The counter drive gear 314 meshes with the drive gear 301, and is constituted so as to rotate with the drive gear 301. The drive gear 301 rotates with the rotation of the input shaft 300, when the rotation of the engine is transmitted to the input shaft 300 by the engagement of the starting clutch. It is constituted so that when the drive gear 301 rotates, the counter drive gear 314 meshing with the drive gear 301 rotates, and the counter shaft 315 fixed with the counter drive gear 314 rotates. The counter shaft 315 is fixed with a counter 3rd gear 316 to the rearward side of the car body at a predetermined interval from the counter drive gear 314, and is fixed with a counter 2nd gear 317 to the rearward side of the car body at a predetermined interval from the counter 3rd gear 316.

Also, to the rearward side of the car body from the counter 2nd gear 317, there is fixed a counter 1st gear 318 at a predetermined interval from the counter 2nd gear 317. Moreover, to the rearward side of the car body from the counter 1st gear 318, there is fixed a counter 5th gear 322 at a predetermined interval from the counter 1st gear 318.

The counter 3rd gear 316 is meshed with a 3rd gear 303, which is provided to the output shaft 323 so as to rotate freely. To the output shaft 323, there is provided a cogged clutch 302 between the 3rd gear 303 and the drive gear 301. The cogged clutch 302 is engaged to the output shaft 323, and is constituted so as to rotate together with the output shaft 323. That is, the cogged clutch 302 is engaged to the output shaft 323, is constituted so as to slide freely on the output shaft 323, and transmits the rotation of the input shaft 300 to the output shaft 323 by shifting the cogged clutch 302 in the frontward direction of the car body so as to engage the cogged clutch 302 with the drive gear 301 (fourth speed position), or transmits the rotation of the input shaft 300 to the output shaft 323 via the counter 3rd gear 316 with the gear shifted by shifting the cogged clutch 302 in the rearward direction of the car body so as to engage the cogged clutch 302 with the 3rd gear 303.

Also, the counter 2nd gear 317 is meshed with a 2nd gear 304, which is provided to the output shaft 323 so as to rotate freely. Moreover, the counter 1st gear 318 is meshed with a 1st gear 306, which is provided to the output shaft 323 so as to rotate freely. To the output shaft 323, there is provided a cogged clutch 305 between the 2nd gear 304 and the 1st gear 306. The cogged clutch 305 is engaged to the output shaft 323, and is constituted so as to rotate together with the output shaft 323. That is, the cogged clutch 305 is engaged to the output shaft 323, is constituted so as to slide freely on the output shaft 323, and transmits the rotation of the input shaft 300 via the counter 2nd gear 317 with the gear shifted by shifting the cogged clutch 305 in the frontward direction of the car body so as to engage with the 2nd gear 304. Also, the cogged clutch 305 transmits the rotation of the input shaft 300 via the counter 1st gear 318 with the gear shifted by shifting the cogged clutch 305 in the rearward direction of the car body so as to engage with the 1st gear 306. Therefore, even if the counter shaft 315 rotates and the counter 2nd gear 317, the counter 1st gear 318 rotates, the rotational force of the counter shaft 315 is not output to the output shaft 323 as long as the cogged clutch 305 is meshed with neither the counter 2nd gear 317 nor the counter 1st gear 318.

The operation of the cogged clutch 302 and the cogged clutch 305 is performed by moving a striking rod 311 via a striking arm 312, by operating the actuator of a shift select controller 5. The shift select controller 5 operates the switching of the shift gear, selected from the accelerator command value output based on the accelerator pedal position of the driver and the current speed of the automobile.

At the rearward side of the vehicle of the counter shaft 315 than an intermediate plate 307, there is fixed a reverse counter gear 319. The reverse counter gear 319 operates when the vehicle moves backward. The reverse counter gear 319 is meshed with a reverse idler gear 320 mounted to a reverse shaft 321 so as to rotate freely, as is shown in FIG. 3. The reverse idler gear 320 is constantly rotated by the reverse counter gear 319 rotating with the rotation of the counter shaft 315. A reverse gear 309 is provided to the output shaft 323 so as to rotate freely. To the frontward of the vehicle from the reverse gear 309, a cogged clutch 308 is provided and engaged to the output shaft 323.

Moreover, the counter 5th gear 322 is fixed to the rearward side of the vehicle at a predetermined interval from the reverse counter gear 319 on the counter shaft 315. The counter 5th gear 322 meshes with a 5th gear 310, which is provided to the output shaft 323 so as to rotate freely. The 5th gear 310 transmits the output of the input shaft 300 to the output shaft 323 by engaging with the cogged clutch 308 provided and engaged to the output shaft 323. That is, the cogged clutch 308 is constituted so as to slide freely on the output shaft 323, and transmits the output of the input shaft 300 via the counter 5th gear 322 with the gear shifted by shifting the cogged clutch 308 to the rearward direction of the car body, so as to engage with the 5th gear 310. Therefore, even when the counter 5th gear 322 rotates with rotation of the counter shaft 315, the rotational force of the counter shaft 315 is not output to the output shaft 323, as long as the cogged clutch 308 is not meshed.

Moreover, to the rearward side of the vehicle at a predetermined interval from the 5th gear 310 on the output shaft 323, there is provided an assist clutch 6, as is shown in FIG. 2. The assist clutch 6 has a clutch plate 61 fixed to the output shaft 323, as is shown in FIG. 5. The clutch plate 61 is constantly rotating with the rotation of the output shaft 323. Opposing to the clutch plate 61, an assist gear 325 provided with a rotating plate which presses against the clutch plate 61 is provided on the output shaft 323 so as to rotate freely. The assist gear 325 is meshed with a counter assist gear 324, which is fixed to the counter shaft 315. Therefore, the counter assist gear 324 rotates in synchronous to the rotation of the counter shaft 315, as long as the counter shaft 315 is rotating, and the assist gear 325 meshing with the counter assist gear 324 is constantly rotated by the rotation of the counter assist gear 324. When the clutch plate 61 and the assist gear 325 is engaged, the rotational force of the counter shaft 315 is transmitted to the clutch plate 61 via the counter assist gear 324 and the assist gear 325, thereby rotating the clutch plate 61, and rotating the output shaft 323 by the rotation of the clutch plate 61, so as to provide assist force of the assist clutch 6 to the output shaft 323.

As seen from above, the assist gear 325 is provided to the output shaft 323 so as to rotate freely, in order to rotate independently of the output shaft 323. Because the clutch plate 61 is fixed to the output shaft 323 provided with the assist clutch 6, and the rotation of the counter shaft 315 is transmitted to the output shaft 323 via the counter assist gear 324 through the assist gear 325 and the clutch plate 61, by engaging the clutch plate 61 and the assist gear 325 from operating the assist clutch 6, the rotational force of the input shaft 300 could be assisted to the output shaft 323 by the operation of the assist clutch 6, when rotation of the input shaft 300 is not transmitted to the output shaft 323 (during neutral) during the period of disengagement of the currently engaged gear and the engagement of a new gear at shifting. Therefore, the shock originated during the period of disengagement of the currently engaged gear and the engagement of the new gear at shifting could be eliminated.

By providing the assist clutch 6 to the output shaft 323, the axial center of the axial clutch 6 could coincide to that of the output shaft 323, so that the assist force could be provided to the output shaft 323 in a stable condition. Moreover, by mounting the assist clutch 6 to the output shaft 323, the size of the transmission case 30 could be reduced, and the structure of the automatic transmission 3 could be miniaturized. Furthermore, by providing the assist clutch 6 to the output shaft 323, assembly could be performed with ease.

According to the present embodiment, the location of the assist clutch 6 is the rearward side of the vehicle at a predetermined interval from the 5th gear 310 on the output shaft 323. However, the assist clutch 6 may not necessarily be located to the rearward side of the vehicle from the 5th gear 310, as long as it is provided on the output shaft 323. Taking into consideration the length of the counter shaft 315 and the like, it is ideal to provide the assist clutch 6 to the rearward side of the vehicle at a predetermined interval from the 5th gear 310 on the output shaft 323.

Also, the position of the counter shaft 315 is formed so that it is positioned below the horizontal plane including the central axis of the output shaft 323, as is shown in FIG. 3. The position of the counter shaft 315 is formed so that it is positioned below the horizontal plane including the central axis of the output shaft 323. It should be positioned below the horizontal surface including the central axis of the output shaft 323 and the position is not necessarily specified. However, it is ideally constituted so that the central axis of the counter shaft 315 is positioned perpendicular to the central axis of the output shaft 323, that is, on the connection A of the central axis. By doing so, the counter gear fixed to the counter shaft 315 could be provided to the lowermost portion of the transmission case 30, so that the inner space of the transmission case could effectively be used, and the cooling effect from the oil accumulated to the inner bottom portion of the transmission case could be expected.

The switching of the reverse gear 309 is performed by the cogged clutch 308. The cogged clutch 308 is constituted so as to slide freely on the output shaft 323. By shifting the cogged clutch 308 to the frontward direction of the car body, the reverse gear 309 engaged to the output shaft 323 and the reverse idler gear 320 are meshed, and the rotation of the reverse idler gear 320 is transmitted to the output shaft 323 via the reverse gear 309. When the cogged clutch 308 is engaged to the reverse gear 309, the vehicle moves backward.

The automatic transmission 3 thus constituted is provided at the center of the car body 1 in the moving direction, as is shown in FIG. 4. In the drawing, reference number 2 denotes the engine, 4 denotes the starting clutch, 5 denotes the shift select controller, 6 denotes the assist clutch, 7 denotes a hydraulic unit, and 8 denotes an indicator.

Next, the operation of the automatic transmission 3 will be explained.

First, when the driver turns on the starting switch in the state where the range lever is in the parking (P) position or in the neutral (N) position, the starter motor rotates and starts the engine 2. When the driver moves the range lever to the drive range (D) position after starting of the engine 2, the shift select controller 5 operates the actuator under the command from the range lever, and shifts the cogged clutch 305 engaged to the output shaft 323 to the rearward direction of the vehicle, in order to engage with the 1st gear 306. With the engagement of the cogged clutch 305 with the 1st gear 306, the cogged clutch 305, the 1st gear 306 and the counter 1st gear 318 are meshed.

At this point, the rotation of the input shaft 300 is transmitted to the counter shaft 315 from the drive gear 301 via the counter drive gear 314 to rotate the counter shaft 315, and the rotation of the counter shaft 315 is transmitted to the 1st gear 306 via the counter 1st gear 318. The output shaft 323 rotates with the rotation of the 1st gear 306, thereby rotating the wheels.

In the state where the cogged clutch 305 is shifted to the rearward direction of the vehicle to engage with the 1st gear 306, the input shaft 300 is not rotating, so that the drive gear 301 fixed to the input shaft 300 does not rotate. Therefore, the counter drive gear 314 fixed to the counter shaft 315 meshed to the drive gear 301 does not rotate. Also, because the counter shaft 315 does not rotate, the counter 1st gear 318 fixed to the counter shaft 315 does not rotate.

When the driver operates the accelerator pedal, the starting clutch 4 is gradually engaged, in order to start rotation of the input shaft 300. The rotation of the input shaft 300 rotates the drive gear 301, which is transmitted to the counter drive gear 314 meshed to the drive gear 301 so as to rotate the counter shaft 315. The rotation of the counter shaft 315 rotates the counter 1st gear 318, which is transmitted to the 1st gear 306, so as to rotate the output shaft 323 engaged by the cogged clutch 305, thereby rotating the wheels.

When the driver depresses the accelerator pedal further, engine speed and the vehicle speed increases further. The accelerator command value corresponding to the accelerator pedal position is input to the control apparatus, in order to decide whether the gear position is the 1st gear 306 or the 2nd gear 304 from the accelerator command value and the vehicle speed. When it is determined as being within the range of the 2nd gear 304, a drive command is output from the control apparatus to the shift select controller 5. The actuator operates based on the drive command of the shift select controller 5, to shift the cogged clutch 305 engaged to the output shaft 323 to the frontward direction of the vehicle to disengage the mesh with the 1st gear 306, and to further shift the cogged clutch 305 to the frontward direction of the vehicle to engage with the 2nd gear 304. When shifting from the 1st gear 306 to the 2nd gear 304, the cogged clutch 305 becomes temporarily disengaged from either the 1st gear 306 or the 2nd gear 304, between disengagement with the 1st gear 306 and the engagement with the 2nd gear 304. At this point, the driver feels no acceleration from depressing the accelerator pedal, and the shock of temporary deceleration is originated. The assist mechanism operates in order to dissolve the shock of the driver during shifting.

When the driver depresses the accelerator pedal in order to increase speed, in the state where the starting clutch 4 is engaged, the rotation of the counter shaft 315 rotates the counter 1st gear 318 to rotate the output shaft 323, and the vehicle is running, the engine speed increases and the accelerator command value corresponding to the accelerator pedal position is input to the control apparatus. The control apparatus decides whether the gear position is the 2nd gear 304 or the 3rd gear 303 from the accelerator command value output from the accelerator pedal and the speed of the vehicle (vehicle speed). When it is decided as within the range of the 3rd gear 303, a drive command is output from the control apparatus to the shift select controller 5 to operate the actuator, and the cogged clutch 305 engaged to the output shaft 323 is shifted to disengage the mesh with the 2nd gear 304.

At the same time, the cogged clutch 302 engaged to the output shaft 323 in the non-engaged position is shifted to the rearward direction of the vehicle, to engage with the 3rd gear 303. With engagement of the cogged clutch 302 to the 3rd gear 303, the cogged clutch 302, the 3rd gear 303, and the counter 3rd gear 316 are meshed. Therefore, the rotation of the input shaft 300 rotates the counter shaft 315 from the drive gear 301 via the counter drive gear 314, and the rotation of the counter shaft 315 is transmitted to the 3rd gear 303 via the counter 3rd gear 316. The output shaft 323 rotates in proportion to the 3rd gear 303 with the rotation of the 3rd gear 303, resulting in high-speed rotation of the wheels, and increase in vehicle speed.

When the gear is shifted from the 1st gear 306 to the 2nd gear 304, the rotation of the input shaft 300 is transmitted to the counter shaft 315 from the drive gear 301 via the counter drive gear 314. The rotational force of the input shaft 300 transmitted to the counter shaft 315 is transmitted to the 2nd gear 304 meshing with the counter 2nd gear 317 via the counter 2nd gear 317, rotates the output shaft 323, and is provided to the wheels.

When shifting to the 2nd gear 304 or to the 3rd gear 303, there temporarily exists a non-engaged condition when neither of the 2nd gear 304 nor the 3rd gear 303 is engaged with the output shaft 323. The non-engaged condition is the condition when the engine output, that is, rotating force of the input shaft 300, is temporarily not transmitted to the output shaft 323. Therefore, under the non-engaged condition, the engine output is not transmitted to the output shaft 323 via the input shaft 300, so that the driver feels no acceleration from depressing the accelerator pedal, and the shock of temporary deceleration during shifting is originated. The assist mechanism operates in order to moderate the shock of the driver during shifting.

The assist mechanism at shifting when the gear is switched operates as is shown in FIG. 5 through FIG. 7. The case where the gear is switched from the 2nd gear 304 to the 3rd gear 303 will be explained below as an example.

FIG. 5 shows the condition where the cogged clutch 305 is shifted to the frontward direction of the vehicle and engaged with the 2nd gear 304.

The condition shown in FIG. 5 is the condition where the 2nd gear 304 rotated by meshing with the counter 2nd gear 315, which rotates together with the rotation of the counter shaft 317 and which is fixed to the counter shaft 315, is engaged with the output shaft 323 by shifting the cogged clutch 305 to the frontward direction of the car body, so that the rotational force of the input shaft 300 is transmitted to the output shaft 323 via the counter 2nd gear 317. That is, the rotational force of the input shaft 300 is transmitted to the counter shaft 315 from the drive gear 301 via the counter drive gear 314 to rotate the counter shaft 315, and the rotation of the counter shaft 315 is transmitted with the gear shifted via the counter 2nd gear 317. At this point, the clutch plate 61 of the assist clutch 6 is rotated by the rotation of the output shaft 323, and the counter assist gear 324 is rotated from the rotation of the counter shaft 315. The assist gear 325 meshing with the counter assist gear 324 is idling above the output shaft 323 from the rotation of the counter assist gear 324.

In such state, the assist gear 325 meshing with the counter assist gear 324 fixed to the counter shaft 315 and idling above the output shaft 323, is not engaged with the clutch plate 61, as is shown in FIG. 5. The assist gear 325 is rotating above the output shaft 323 independently of the output shaft 323, from the rotation of the counter shaft 315 via the counter assist gear 324. The assist gear 325 is constantly idling above the output shaft 323, as long as the counter shaft 315 is rotating, so that the rotational force transmitted to the input shaft 300 from a flywheel 330 via the starting clutch 4 is not provided to the clutch plate 61.

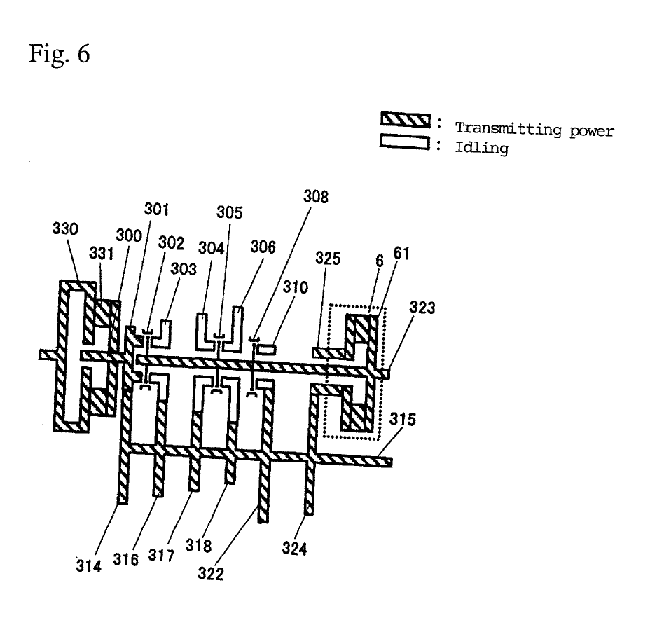

When the operation command for shifting from the 2nd gear 304 to the 3rd gear 303 is output under such condition, the cogged clutch 305 is shifted to the rearward direction of the vehicle to disengage from the 2nd gear 304, and the cogged clutch 302 is shifted to the rearward direction of the vehicle to engage with the 3rd gear 303. When shifting operation command is output, the command for operating the assist clutch 6 is output, so that the assist clutch 6 operates before the cogged clutch 305 disengages from the 2nd gear 304, and engages with the assist gear 325 by pressing against the clutch plate 61 with hydraulic pressure, as is shown in FIG. 6. The engagement of the cogged clutch 305 and the 2nd gear 304 is disengaged thereafter. With such operation, the rotation of the counter assist gear 324 is transmitted to the clutch plate 61 via the assist gear 325. FIG. 6 shows the non-engaged condition where the cogged clutch 305 is disengaged from the 2nd gear 304, and the cogged clutch 302 is also disengaged from the 3rd gear 303.

With the rotation of the counter assist gear 324, the rotation of the counter shaft 315 is transmitted to the assist gear 325 meshing with the counter assist gear 324. The clutch plate 61 engaged to the assist gear 325 is fixed to the output shaft 323, so that the assist clutch 6 operates. When the clutch plate 61 and the assist gear 325 engages, the rotation of the counter assist gear 324 rotated by the counter shaft 315 is transmitted to the assist gear 325 meshing with the counter assist gear 324, and is transmitted to the output shaft 323 by the clutch plate 61 engaged to the assist gear 325.

As is seen from above, even when the non-engaged condition where neither of the 2nd gear 304 nor the 3rd gear 303 is engaged temporarily exists during shifting from the 2nd gear 304 to the 3rd gear 303, the rotation transmitted to the input shaft 300 from the flywheel 330 via the starting clutch 4 is transmitted from the drive gear 301 via the counter drive gear 314, the counter shaft 315, the counter assist gear 324, the assist gear 325, the clutch plate 61, and the output shaft 323, with the operation of the assist clutch 6. Therefore, obstructing of operation of the drive force to the output shaft 323 during non-engaged condition at shifting could be prevented, so that the shock at shifting could be moderated.

After the assist mechanism performs assistance, the cogged clutch 302 is shifted to the rearward direction of the vehicle to engage with the 3rd gear 303, as well as the assist clutch 6 operates to disengage the assist gear 325 from the clutch plate 61.

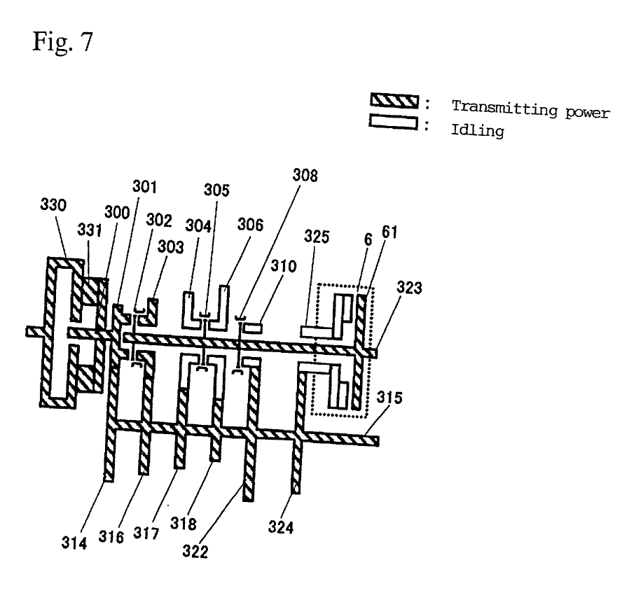

FIG. 7 shows the condition where the cogged clutch 305 is held at the neutral position, the cogged clutch 302 is engaged with the 3rd gear 303, and the assist gear 325 and the clutch plate 61 are disengaged. As is shown in the drawing, when the cogged clutch 302 is engaged with the 3rd gear 303, the rotation of the input shaft 300 is transmitted to the counter shaft 315 from the drive gear 301 via the counter drive gear 314, and the rotation of the counter shaft 315 is transmitted to the 3rd gear 303 via the counter 3rd gear 316, and to the output shaft 323 via the 3rd gear 303 engaged with the output shaft 323 by the cogged clutch 302.

When the driver attempts to increase the speed by depressing the accelerator pedal further, the engine speed increases, and the increased speed increases the rotation of the counter shaft 315 via the drive gear 301. When the speed of the vehicle (vehicle speed) reaches the limit of driving in 3rd gear 303, the control apparatus detects that the gear position is within the range of the 4th gear 301 (drive gear) from the accelerator command value and the vehicle speed, and outputs the drive command from the control apparatus to the shift select controller 5. By operating the actuator, the cogged clutch 302 engaged to the output shaft 323 is shifted to the frontward direction of the vehicle to disengage the mesh with the 3rd gear 303, and the cogged clutch 302 is shifted further to the frontward direction of the vehicle to engage with the 4th gear 301 (drive gear). When the gear is shifted from the 3rd gear 303 to the 4th gear 301 (drive gear), the rotation of the input shaft 300 is transmitted directly to the output shaft 323 from the drive gear 301, so that the output shaft 323 is rotated by the rotation of the input shaft 300 itself.

When the gear is shifted from the 3rd gear 303 to the 4th gear 301, there temporarily exists a non-engaged condition where neither of the 3rd gear 303 nor the 4th gear 301 is engaged with the output shaft 323. Under the non-engaged condition, the driver feels no acceleration from depressing the accelerator pedal, and the shock of temporary deceleration during shifting is originated. The assist clutch 6 operates in order to moderate the shock of the driver during shifting, as is mentioned above. The operation of the assist clutch 6 is the same as is mentioned above.

Likewise, when the gear is shifted from the 4th gear 301 to the 5th gear 310, there temporarily exists a non-engaged condition where neither of the 4th gear 301 nor the 5th gear 310 is engaged with the output shaft 323. Under the non-engaged condition, the driver feels no acceleration from depressing the accelerator pedal, and the shock of temporary deceleration during shifting is originated. The assist clutch 6 operates in order to moderate the shock of the driver during shifting, as is mentioned above. The operation of the assist clutch 6 is the same as is mentioned above.

When the driver slackens the accelerator pedal when the shift gear is in the position of the 3rd gear 303, the speed of the vehicle lowers, and vehicle speed is slowed down. Then, the control apparatus detects that the gear position entered the range of the 2nd gear 302 from the range of the 3rd gear 303, from the accelerator command value and the vehicle speed, and outputs drive command from the control apparatus to the shift select controller 5. By operating the actuator, the cogged clutch 302 engaged to the output shaft 323 is shifted to the frontward direction of the vehicle to disengage the mesh with the 3rd gear 303. At the same time, the cogged clutch 305 engaged to the output shaft 323 and in a position of non-engagement is shifted to the frontward direction of the vehicle to engage with the 2nd gear 304. With the engagement of the cogged clutch 305 with the 2nd gear 304, the cogged clutch 305, the 2nd gear 304, and the counter 2nd gear 317 are meshed.

Therefore, the rotation of the input shaft 300 rotates the counter shaft 315 from the drive gear 301 via the counter drive gear 314, and the rotation of the counter shaft 315 is transmitted to the 2nd gear 304 via the counter 2nd gear 317. With the rotation of the 2nd gear 304, the output shaft 323 rotates in proportion to the 2nd gear 304 with the rotation of the 2nd gear 304, so that vehicle speed is slowed down. When the speed of the vehicle is lowered from the slacking of the accelerator pedal by the driver, in the condition where the gear is the 3rd gear 303, shifting is performed under slow-down of the vehicle speed so that there exists no shock from shifting, even when there is originated a temporary non-engaged condition during shifting from the 3rd gear 303 to the 2nd gear 304. Therefore, the assist mechanism does not perform assistance.

Also, during shifting from the 2nd gear 304 to the 1st gear 306, the speed of the vehicle is lowered by the slacking of the accelerator pedal by the driver, as is the case with shifting from the 3rd gear 303 to the 2nd gear 304, so that there exists no shock from shifting, even when there is originated a temporary non-engaged condition during shifting from the 2nd gear 304 to the 1st gear 306. Therefore, the assist mechanism does not perform assistance.

According to the embodiment of the present invention, the assist clutch 6 assists the rotation to the output shaft 323 under the non-engaged condition during shifting from the 1st gear to the 2nd gear, from the 2nd gear to the 3rd gear, from the 3rd gear to the 4th gear, and from the 4th gear to the 5th gear, so that the accelerating power is transmitted to the output shaft 323 during accelerated but non-engaged condition, resulting in moderating the shock the driver feels as if the vehicle has decelerated. That is, even when a mesh type transmission provided with a clutch for engaging and disengaging the shift gear and the output shaft is used, the shock originated from engagement and disengagement of the clutch during acceleration could be moderated.

Also, according to the present embodiment, a mesh type transmission for transmitting power of the input shaft 300 to the output shaft 323 by engaging the plurality of cogged clutches 302, 305, 308 with the plurality of shift gears 301, 303, 304, 306, 310 is used, and the automatic transmission, which performs automatic shifting by controlling engagement of the plurality of cogged clutches 302, 305, 308 for engaging and disengaging the voluntary shift gears 301, 303, 304, 306, 310 with the output shaft 323 to the shift gear determined from the accelerator command value and the vehicle speed, is provided with the assist mechanism for transmitting rotational force of the input shaft 300 to the output shaft 323, when no cogged clutch is engaged with any of above-mentioned plurality of shift gears during switching of the cogged clutch. Therefore, the shock originated from engaging and disengaging of the clutch during acceleration could be moderated.

Moreover, according to the present embodiment, a mesh type automatic transmission equipped with the plurality of shift gears 301, 303, 304, 306, 310 provided so as to rotate freely to the output shaft 323 for providing driving force to the wheels, the plurality of cogged clutches 302, 304, 308 engaging with the output shaft 323, and the plurality of counter shift gears 314, 316, 317, 318, 322 corresponding to each speed, which are fixed to the counter shaft 315 rotated by the rotation of the input shaft 300 rotated from the power of the engine 2, and which mesh with the plurality of shift gears 301, 303, 304, 306, 310, for performing automatic shifting by controlling engagement of the plurality of cogged clutches 302, 305, 308 with the voluntary shift gears 301, 303, 304, 306, 310 of the plurality of shift gears 301, 303, 304, 306, 310 determined from the accelerator command value and the vehicle speed, is used. The automatic transmission is provided with the assist mechanism for assisting transmission of the rotational force of the input shaft 300 to the output shaft 323 via the assist gear 325 which rotates from the rotation of the counter shaft 315, during non-engagement when no cogged clutch of the plurality of cogged clutches 302, 305, 308 is engaged with any of the plurality of shift gears 301, 303, 304, 306, 310, occurring during switching when an engaged cogged clutch of the plurality of cogged clutches 302, 305, 308 is disengaged and one of the cogged clutch of the plurality of cogged clutches 302, 305, 308 is to be engaged. Therefore, during non-engagement when the cogged clutch and the shift gear is disengaged during switching of the shift gear, the rotation of the input shaft 300 (counter shaft 315) could be assisted to the output shaft 323, so that shock originated by engaging and disengaging of clutch during acceleration could be moderated, even when a mesh type transmission provided with clutches for engaging and disengaging the shift gears 301, 303, 304, 306, 310 with the output shaft 323 is used.

Furthermore, according to the present embodiment, the position for providing the counter shaft 315 is formed so as to be positioned below the horizontal plane including the central axis of the output shaft 323, so that the assist mechanism could be provided to the lowermost portion of the transmission case 30, enabling effective use of the interior space of the transmission case, as well as enabling expectance for cooling effect from the oil. Moreover, the assist mechanism could be mounted to a position not blocking the gear oil injection hole.

Still further, according to the present embodiment, the assist clutch 6 is provided to the output shaft 323 at the rearward side of the car body, so that mounting of the assist clutch 6 is made simple.

Still further, by mounting the assist clutch 6 to the output shaft 323, the size of the transmission case 30 could be reduced, and the structure of the automatic transmission 3 could be miniaturized.

As is mentioned above, the present invention moderates the shock originated from engaging and disengaging of the clutch during acceleration.

We claim:

1. A mesh type automatic transmission equipped with an input shaft for introducing power of an engine, a plurality of shift gears, a plurality of cogged clutches, an output shaft for outputting driving force, a counter shaft, and a plurality of counter gears, for transmitting power of the engine to said output shaft by rotating said input shaft with the power of the engine, rotating said counter shaft by rotation of said input shaft, and transmitting rotation of said counter shaft to said output shaft via said counter gear with automatic shifting by engaging and disengaging said cogged clutch to one of said shift gears corresponding to speed; wherein
an assist mechanism for transmitting rotational force of said input shaft to said output shaft by transmitting rotation of said counter shaft via said assist gear, in the period of disengagement of a gear to engagement of a new gear during said shifting, is provided to said output shaft.

2. An automatic transmission according to claim 1, wherein said assist mechanism is provided to the rearward side of a car body than the rearmost gear of said output shaft.

3. An automatic transmission according to any of claims 1 or 2, wherein said assist mechanism starts engaging when a switch command of said cogged clutch is output before said cogged clutch currently engaged with said shift gear is completely disengaged, engages corresponding to torque of an engine to transmit rotational force of said input shaft to said output shaft when said cogged clutch is completely disengaged from said engaged shift gear, and disengages when said cogged clutch is engaged with said shift gear to be engaged according to said switch command.

4. An automatic transmission according to any of claims 1, 2 or 3, wherein said assist mechanism is comprised of an assist clutch, which is constituted from a clutch plate fixed to said output shaft and rotated with said output shaft, and from an assist gear provided so as to rotate freely on said output shaft for transmitting rotation of said counter shaft to said clutch plate by pressing against said clutch plate, and a counter assist gear fixed to said counter shaft and meshed with said assist gear of said assist clutch, and the rotation of said counter assist gear is transmitted to said output shaft via said assist gear and said clutch plate, based on an assist command.
